(19) United States
(12) Patent Application Publication
(10) Pub. No.: US 2006/0084539 A1
(43) Pub. Date: Apr. 20, 2006

(54) Guide device for a chain of a timing system of an internal combusion engine

(75) Inventors: Lorenzo Covini, Milano (IT); Massimo Carugati, Vimercate (IT)

Correspondence Address: BORGWARNER INC., 3850 HAMLIN ROAD, AUBURN HILLS, MI, 48326, US

(73) Assignee: Morse TEC Europe, S.r.l., Milano (IT)

(21) Appl. No.: 11/226,089

(22) Filed: Sep. 14, 2005

(30) Foreign Application Priority Data
Oct. 15, 2004 (EP) 04425781.4

(51) Int. Cl. F16H 7/08; F16H 7/18

(52) U.S. Cl. 474/111; 474/140

(57) ABSTRACT

A guide device for a chain of an internal combustion engine includes a support structure and a body. The support structure is mounted to the engine and has at least one protruding body at one end of the structure on a first side. The body has a chain sliding surface that slidably receives the chain. Opposite the chain sliding face is a seat for receiving the protruding body of the support structure. The seat is symmetrically shaped and receives the protruding body in a first position and a second position. The first position is specular to the second position.

### REFERENCE TO RELATED APPLICATIONS

This application claims priority from European Patent Application No. 04425781.4, filed Oct. 15, 2004, entitled, “GUIDE DEVICE FOR THE CHAIN OF THE TIMING SYSTEM OF AN INTERNAL COMBUSTION ENGINE, IN PARTICULAR OF A V-ENGINE” under the benefit of 35 USC §119 (a)-(d) or § 365(b). The aforementioned application is incorporated herein by reference.

### BACKGROUND OF THE INVENTION

1. Field of the Invention

The invention pertains to the field of guide devices. More particularly, the invention pertains to a guide device for a V-engine.

2. Description of Related Art

A timing system of an internal combustion engine can be timed by using a chain transmission, where the chain is wound on one or more sprockets. One of the two sprockets is a drive sprocket and takes its drive (even indirectly) from the drive shaft to transmit it to one or more shafts.

In an internal combustion engine, the intake and exhaust camshafts (of each cylinder block, if the engine comprises more than one cylinder block) are moved by a chain transmission. The area between the camshafts is supported by a guide device, known in the art as a “cam to cam guide” and includes a supporting structure which bears a sliding surface on which the chain slides.

In engines including two cylinder blocks arranged as a V, the intake and exhaust camshafts have different heights, and the shapes of the sliding surfaces of the “cam to cam guides” are specular to or mirror images of each other. Therefore, it is not possible to use the same guide device for both cylinder blocks. Since the same guide devices may not be used, the production, transport and storage costs for the guide devices increase.

The object of the present invention is to provide a “cam to cam” guide suitable to overcome the aforementioned drawbacks.

### SUMMARY OF THE INVENTION

A guide device for a chain of an internal combustion engine includes a support structure and a body. The support structure is mounted to the engine and has at least one protruding body at one end of the structure on a first side. The body has a chain sliding surface that slidably receives the chain. Opposite the chain sliding face is a seat for receiving the protruding body of the support structure. The seat is symmetrically shaped and receives the protruding body in a first position and a second position. The first position is specular to the second position.

### BRIEF DESCRIPTION OF THE DRAWINGS

FIG. 1 shows diagrammatically the guide chains of the two cylinder blocks of a V-engine and the “cam to cam” guides relating to the chains.

FIG. 2a shows diagrammatically a first perspective view of the supporting structure of the “cam to cam” guide of the present invention.

FIG. 2b shows diagrammatically a second perspective view of the supporting structure of the “cam to cam” guide of the present invention.

FIG. 3a shows diagrammatically a first perspective view of the body of the “cam to cam” guide of the present invention, which bears the sliding surface for a chain.

FIG. 3b shows diagrammatically a second perspective view of the body of the “cam to cam” guide of the present invention, which bears the sliding surface for a chain.

FIG. 3c shows an enlarged side view of the body of the “cam to cam” guide, of the present invention, which bears the sliding surface for a chain of FIG. 3b.

FIG. 4a shows diagrammatically a first perspective view of one of the “cam to cam” guides of FIG. 1, in which the body of FIG. 3 is mounted on the supporting structure of FIG. 2.

FIG. 4b shows diagrammatically a second perspective view of one of the “cam to cam” guides of FIG. 1, in which the body of FIG. 3 is mounted on the supporting structure of FIG. 2.

### DETAILED DESCRIPTION OF THE INVENTION

In the appended drawings corresponding elements are identified by the same reference numerals.

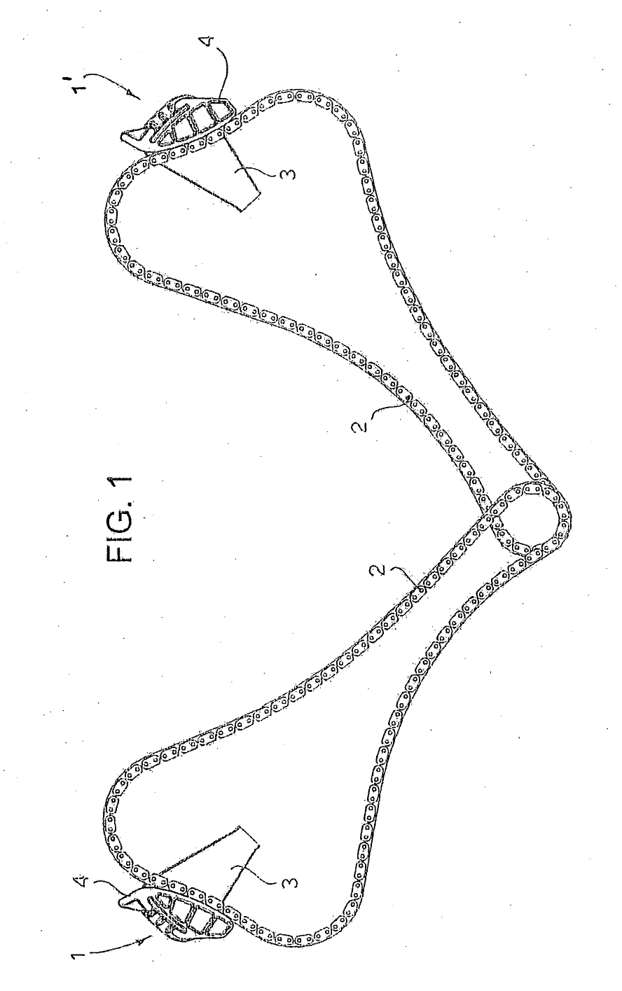

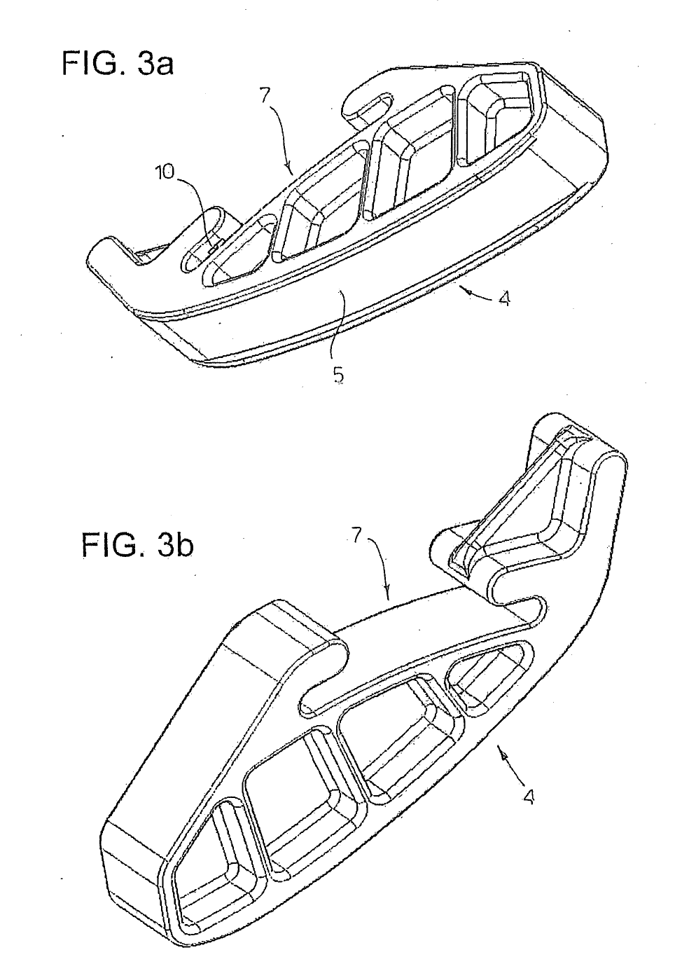

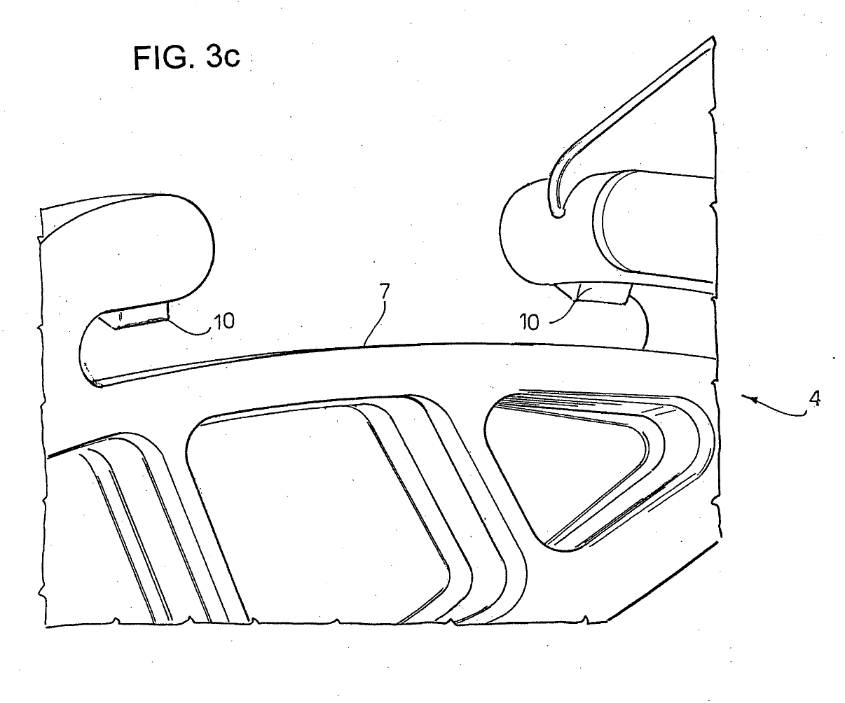

FIG. 1 shows the chains 2 driven by a drive shaft, which drives the camshafts of the two cylinder blocks of a V-engine and the guide devices 1, 1′ relating to the chains 2. As can be seen from FIG. 1, the guide devices 1, 1′ are specular to each other or a mirror image of each other and each have a supporting structure 3, fixed in a known manner to the engine body, which carries a body 4. The body 4 has a sliding surface 5 (FIG. 3) for slidably receiving one of the chains 2 and a coupling means that allows the body 4 to be mounted on the supporting structure 3 in two positions specular to each other.

The body 4 is preferably made of aluminum or of plastic material reinforced with fiberglass. The sliding surface 5 is preferably made of a plastic material with a low coefficient of friction.

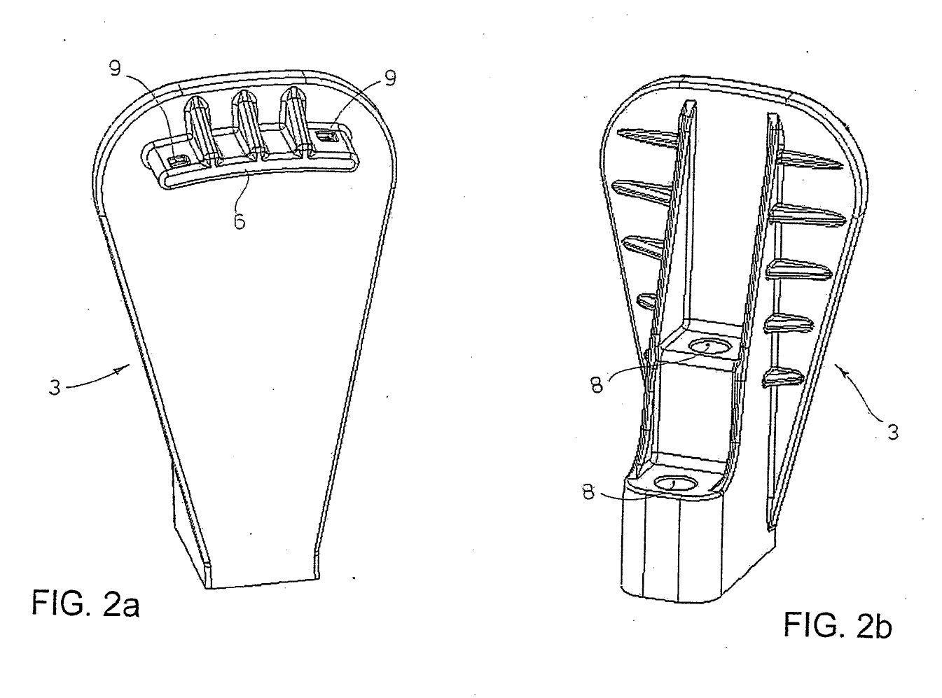

FIG. 2a shows a first perspective view of the side of the supporting structure 3 shown in FIG. 1. FIG. 2b shows a second perspective view of the opposite side of the supporting structure which carries a means for mounting the supporting structure 3 to the engine body.

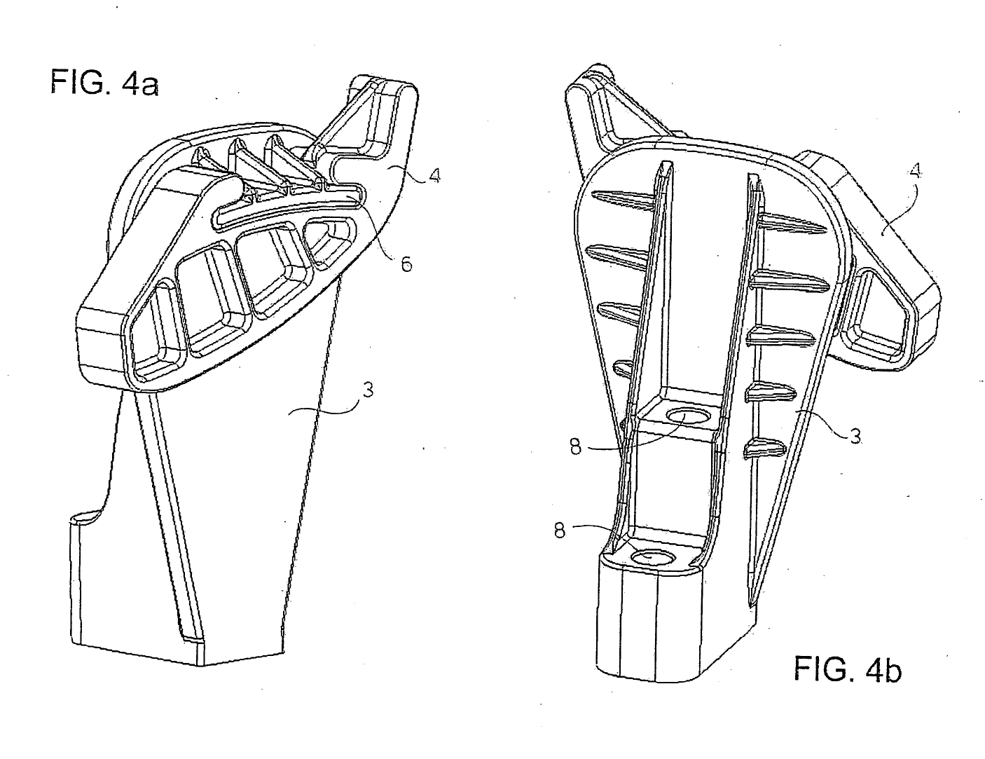

In FIG. 2b the fixing means, also shown in FIG. 4b, includes two perforated flanges 8 in which a bolt or other equivalent mounting means is inserted into, connecting the supporting structure 3 to the engine body.

FIG. 2a shows the supporting structure 3 with a protruding body or bracket 6, at one end at substantially right angles to the longitudinal axis of the supporting structure 3. The protruding body or bracket 6 of the supporting structure engages or is received by a seat 7 formed on the side of the body 4 opposite of the sliding surface, as shown in FIG. 4a. The bracket 6 and the seat 7 of the body 4 are symmetrical in shape with respect to their transverse axis, which allows the body 4 to be applied to the supporting structure 3 in two positions specular to each other.

In a preferred embodiment, a pair of holes 9 on the top surface of the bracket 6 receive a pair of teeth 10 integrally formed on the inner surface of seat 7 of the body 4 to lock the body 4 to the supporting structure 3. The pair of teeth 10 have a shape and an arrangement complementary to that of the holes 9, as shown in FIGS. 2a and 3c. The pair of holes 9 and the pair teeth 10 are advantageously hemi-symmetric with respect to the longitudinal axis of the bracket 6 and of the body 4, respectively, and may be omitted without departing from the scope of the invention.

FIGS. 3a and 3b shows perspective views of the body 4, which bears the sliding surface 5 for the chain 2. Opposite the sliding surface 5 that slidably receive the chain is seat 7 that receives bracket 6. FIG. 3c shows an exploded view of the seat 7 and integrally formed teeth 10 on the inner surface of the seat.

FIG. 4a shows the body 4 mounted on the supporting structure 3 by inserting the bracket 6 of the supporting structure 3 into the seat 7 of the body 4. FIG. 4b shows the rear part of the supporting structure 3, which carries the body 4 and two perforated flanges 8 in which is inserted a bolt for fixing the supporting structure 3 to the engine body.

The guide device 1′ of FIG. 1 has a specular structure with respect to that of the guide device 1 and is rotated 180° with respect to the position shown in FIG. 4 and then mounted to the body 4 on support structure 3.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A guide device (1, 1′) for a chain of an internal combustion engine comprising:
a supporting structure (3) mounted to the engine comprising at least one protruding body (6) at one end of the structure on a first side;
a guide body (4) comprising a chain sliding surface (5) for slidably receiving the chain (2) on one side and a seat (7) formed opposite the chain sliding surface (5) for receiving the at least one protruding body (6) of the supporting structure (3);
wherein the protruding body (6) is received by the seat (7) of the guide body (4) in either a first position or a second position, wherein the first position is specular to the second position.

2. The guide of claim 1, wherein the seat (7) is symmetrically shaped.

3. The guide of claim 1, wherein the protruding body (6) is placed at a right angle relative to a longitudinal axis of the supporting structure (3).

4. The guide of claim 1, wherein the protruding body (6) further comprises a pair of holes (9) on an upper surface for receiving a pair of teeth (10) fixedly attached to an inner surface of the seat (7) of the guide body (4).

5. The guide of claim 4, wherein the pair of holes (9) and the pair of teeth (10) are hemi-symmetrical with respect to a longitudinal axis of the protruding body (6) and the guide body (4).

6. The guide of claim 1, further comprising a pair of perforated flanges (8) on a second side of the supporting structure (3), opposite the first side, to mount the supporting structure (3) to the engine.

7. The guide of claim 1, wherein the guide body (4) is aluminum.

8. The guide of claim 1, wherein the guide body (4) is plastic reinforced with fiberglass.

9. The guide of claim 1, wherein the sliding surface (5) of the guide body (4) is made of a material with a low coefficient of friction.

10. The guide of claim 9, wherein the sliding surface (5) of the guide body (4) is plastic.
